(19) United States
(12) Patent Application Publication
(10) Pub. No.: US 2022/0051316 A1
(43) Pub. Date: Feb. 17, 2022

(54) Credit-Based Installment Financing

(71) Applicant: The Toronto-Dominion Bank, Toronto (CA)

(72) Inventors: Sebastien Bouchard, Ottawa (CA); Asgar Maleki, Toronto (CA); Hayley F. Doyle, Ottawa (CA); Jacqueline Hannah Lee Aldrovandi, Hamilton (CA); Otis P. Coker, Ottawa (CA); Jaspreet Kaur Aulakh, Brampton (CA); Josue David Bravo Anez, Toronto (CA); Jeffrey Stuart Burton, Toronto (CA); Laura Marie Aquino Arias, Toronto (CA); Michael Woods, Nepean (CA); Sheirline Hanna, Ottawa (CA)

(21) Appl. No.: 16/991,537

(22) Filed: Aug. 12, 2020

(51) Int. Cl. G06Q 40/02; G06Q 20/40; G06Q 20/42

(52) U.S. Cl. CPC G06Q 40/025; G06Q 20/42; G06Q 20/405

(57) ABSTRACT

The present disclosure involves systems, software, and computer implemented methods for providing credit card customers with an offer to finance large, unexpected, or general expenditures on a set installment plan associated with a fixed interest rate or fee. The rate or fee associated with the offer can be a flat one-time fee, a fixed interest rate, or a combination thereof. In some instances, a variable interest rate can be offered. In some instances, the fee can be an ongoing small or nominal fee added to each repayment over a period of time.

### TECHNICAL FIELD

This disclosure generally relates to computer-implemented methods, software, and systems for providing installment financing based on already-completed credit transactions.

### BACKGROUND

Customers using credit cards as a primary payment instrument can incur large amounts of undesirable revolving debt following larger purchases. This can result in decreased flexibility in future purchases and expenditures.

### SUMMARY

In general, this disclosure involves systems, software, and computer implemented methods for automatically providing financing offers based on credit account expenditures. One example implementation includes monitoring at least one user credit account of a plurality of user credit accounts, each user credit account associated with a particular user and including a plurality of transactions. Identifying a request associated with a particular user credit account, the request including a request for financing one or more completed transactions associated with the particular user credit account, the particular user credit account associated with a first user. Analyzing the user credit account of the first user and the one or more completed transactions to determine whether the request satisfies at least one authorization rule allowing the request to be approved and in response to determining the request satisfies at least one authorization rule allowing the financing to be approved: identifying one or more financing options for the one or more completed transactions, each financing option including a fee and repayment period, determining for each financing option that an associated risk is below a predetermined threshold and if it is, approving the financing options, and transmitting a subset of the approved financing options to a user device associated with the first user for acceptance by the first user. In response to receiving an indication of acceptance of a particular one of the transmitted financing options from the first user via the user device: applying the accepted financing option to the one or more completed transactions and updating the particular user credit account associated with the first user with a new balance.

Implementations can optionally include one or more of the following features.

In some instances, when a modification request for a transmitted financing option is received from the first user via the user device: the financing options are modified in accordance with the modification request received from the user device, analyzed to determine, for the modified financing options, whether a risk associated with the modified financing options and the first user is below the predetermined threshold and if the risk is below the predetermined threshold transmitting the modified financing options to the user device associated with the first user for acceptance by the first user, the modified financing options indicating one or more parameters that have been modified form the subset of the approved financing options. In some implementations, the predetermined threshold is a threshold below which risk is deemed acceptable, and is based on a transaction amount, the first user, and a term of the modified financing options.

In some instances, a notification is transmitted to the user device indicating upcoming due payments.

In some instances, after applying the accepted financing options, and available credit amount associated with the user credit account of the first user is modified.

In some instances, the at least one authorization rule comprises at least one of a determination that the at least one transaction is larger than a predetermined amount, a determination that an available balance of the credit account is below a predetermined threshold immediately after the transactions, a determination that the at least one transaction is greater than a predetermined percent of a total balance of the credit account, or a determination that the at least one transaction represents a disproportionately sized transaction as compared to transactions from a transaction history of the first user.

In some instances, a list of eligible transactions can be transmitted to the user device associated with the first user prior to identifying the request associated with the particular user credit account. The eligible transactions can be transactions from the plurality of completed transactions that satisfy one or more authorization rules. In some implementations, the list of eligible transactions is transmitted in response to one or more eligible transactions satisfying at least one offer rule which triggers the transmission.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an overview diagram of a system for offering credit-based financing.

FIG. 2 is a flowchart that describes an example method for offering credit-based financing.

FIG. 3 is a swim-lane diagram depicting example interactions of a client, offer system, and credit account.

FIG. 4 illustrates an example user interface for requesting an installment plan that can be provided by an FI system to a customer.

### DETAILED DESCRIPTION

This disclosure describes a solution for customers using credit cards to provide a fixed (or, alternatively, variable) rate financing offer on certain completed transactions in their credit account, where the financing offer can be made and taken advantage of without relying on typical or existing revolving debt schemes currently available.

In general, the proposed solution provides credit card customers with an offer to finance large, unexpected, or general expenditures on a set installment plan associated with a fixed interest rate or fee. The rate or fee associated with the offer can be a flat one-time fee, a fixed interest rate, or a combination thereof. In some instances, a variable interest rate can be offered. In some instances, the fee can be an ongoing small or nominal fee added to each repayment over a period of time. The offer can be made over a set repayment period, such as 3 months, 6 months, or 9 months, among other timelines. While these terms provide examples, any suitable terms can be applied to such financing offers, including offers that can be modified and proposed by the customer, which can be automatically or manually evaluated by the organization providing and offer, and can be accepted or declined accordingly.

The offer can, in some instances, cover a full cost of a purchase or, alternatively, a set of related or non-related purchases, as well as other amounts. For example, an offer for 50% of the purchase can be provided, or alternatively, 150% of the purchase. Alternative amounts, terms, and combinations thereof can be provided.

Loan terms associated with a particular offer, including whether an offer is made or available at all, can be based on a risk assessment of the customer, including but not limited to a customer's current and projected income, a credit score, a transaction history, and other relevant information. In some instances, artificial intelligence (AI) and machine learning (ML)-based techniques can be used to determine which customers can qualify for such an offer, using any suitable analysis and algorithm.

In one particular implementation, a financial institution (FI) issuing the credit card can monitor purchases made by a customer. Any number of suitable rules or thresholds can be defined from which a determination to authorize and/or offer a credit-based installment plan can be used. In some instances, a large purchase can be defined based on at least one of an absolute purchase amount (e.g., $1,000, $5,000, etc.), a purchase amount relative to account available balance (e.g., 50% of total existing available credit), and/or a large purchase relative to a credit user's recent transactions (e.g., user makes a purchase for $700, but has not spent more than $100 in a single transaction in the last 3 months).

Based on the determination, the FI can perform any suitable creditworthiness analyses for the customer to determine whether the customer qualifies for the offer. If the customer is qualified, a set of terms specific to the offer, including term, rate, and amount, among others, can be provided to the customer. In some instances, the offer can be transmitted from the FI to a user device associated with the customer, and can be presented on the user device, such as through an email, text message, push notification, or other message or notification.

Upon receiving an indication of acceptance of the proposed terms, a new line of credit or installment loan can be opened at the FI according to the terms of the loan, and the amount transaction or transactions being financed can be removed from a current bill or statement, and replaced with the first payment of the newly opened installment plan. In some instances, the customer's available credit remains unchanged and is reduced by the loan amount to be restored as payments are made. In some implementations, the available credit, or a portion thereof, corresponding to the financed amount, is restored following acceptance of the loan, thereby affording the customer more potential purchasing power by assuring fixed repayment to the accepted installment plan while maintaining the purchase power prior to the purchases associated with the loan.

In some instances, the customer can adjust and/or modify the loan parameters from those initially offered by the FI. For example, a different term of the loan can be requested (e.g., pay in 2 months vs. 6 months) or a different loan amount can be requested (e.g., 75% of the transaction vs. 100% of the transaction). In those instances, a user interface (UI) can be provided with the presented offer, or can be accessible via interaction with the offer or a website or application presenting the offer. The UI can include a slider or other UI elements which can be used by the customer to adjust or modify one or more loan parameters. The results of those modifications can then be presented to the customer for further consideration and confirmation. In some instances, the change can require an additional creditworthiness analysis. Alternatively, various thresholds can be pre-approved for the customer, such that the customer is able to adjust at least some of the parameters within a pre-determined or pre-calculated range. In some instances, the UI can present or illustrate those pre-approved variations for easy interaction. If the adjustment remains within the pre-determined or pre-calculated range, an automatic acceptance can be provided to the customer based on the updated terms.

Once the loan is approved, accepted, and the account is updated, the customer can repay the required amounts defined in the agreement. Payments can be made via monthly bills on the credit account, applying of manual payments by the customer, automatic deductions on top of normal payment transactions, or by using alternative funds (e.g., a debit account, a different credit account, a checking account, etc.).

In one example implementation, the solution can be realized using an architecture that includes one or more points-of-sale (POS) or websites where the transaction occurs (or other alternative locations or payment points), a financial system managing a customer's account, and a user device associated with the customer. The financial system can manage, store, and monitor transactions for a plurality of its customers and can define particular parameters and triggers associated with the current solution. The financial system can store customer account information and historical data, such as trends and analytics, which can be used to identify when new transactions meet the requirements for a particular offer, such as a larger than normal purchase. Information about similarly-situated customers to particular customers can be stored, as well as defined cohort sets and those customers' associated account histories. Furthermore, information about ongoing and incoming transactions, such as a particular customer's purchases/transactions, can be available and monitored.

The financial system can include or be associated with a rules engine associated with various rule sets for different functions and offers. One rule set (e.g., authorization rules) can be defined to identify particular transactions as qualifying for an installment plan offer as described herein. Authorization rules can be based on the customer's prior transaction history, as well as those of similar customers. In some instances, the rules can be based on a comparison of a particular transaction to information about the customer's account, such as an available balance or a credit limit and the proportion of that balance a particular transaction represents. It should be noted that in some instances, a set of related transactions can be associated and an offer representing the amount of those related transactions can be provided, such as purchases at two or more different furniture stores within a particular time period (e.g., one week). In addition to the authorization rules, a set of user offer requirements and thresholds can be defined such that the types of offers and requirements of customers can be evaluated prior to an offer being made. In some instances, the user offer rules can be associated with or be used by a creditworthiness and/or risk analysis engine, which can confirm that a particular offer is allowed for a customer. The risk/creditworthiness analysis can be performed prior to an offer being provided to a customer, as well as after receiving customer adjustments to a prepared offer. The financial system can then transmit, via any suitable channel, prepared offers to user devices associated with a particular customer account for whom an offer has been identified or requested.

The solution can also include one or more user devices, where each device is associated with a particular customer. Some customers can be associated with multiple devices, such that notifications associated with particular offers can be sent to one or more of those user devices. The user devices can be mobile devices, such as smartphones, tablets, watches, laptops, and other suitable devices. The provided offer can be presented within text messages, push notifications, websites, email, instant messaging, FI-related applications, or other suitable channels. Once reviewed and accepted, the user device can communicate with the financial system to initiate the actions associated with the proposed loan. In some implementations, the customer can review and select one or more transactions for which they desire a loan proposal. In these implementations, a list of qualifying transactions can be provided to the customer, as well as validity dates through which the transactions will qualify for an installment plan offer (e.g., a transaction will qualify for financing via installment plan up to 2 months after the transaction, or any time up to 10 days following the payment due date for the transaction, etc.) In some instances, the provided offer can be presented immediately following a transaction. In these instances, the offers may be in real time such that a transaction and an offer are temporally proximate. For example, an individual can perceive that the transaction and the offer occur substantially simultaneously, where the time difference for an offer following the suitable transaction can be less than 1 millisecond (ms) or less than 1 second (s), or the response can be without intentional delay taking into account processing limitations of the system.

To help a person skilled in the art better understand the technical solutions in the present specification, the following clearly and comprehensively describes the technical solutions in the implementations of the present specification with reference to the accompanying drawings in the implementations of the present specification. The described implementations represent merely some, rather than all, of the implementations of the present specification. Other implementations obtained by a person of ordinary skill in the art based on one or more implementations of the present specification without creative efforts shall fall within the protection scope of the implementations of the present specification.

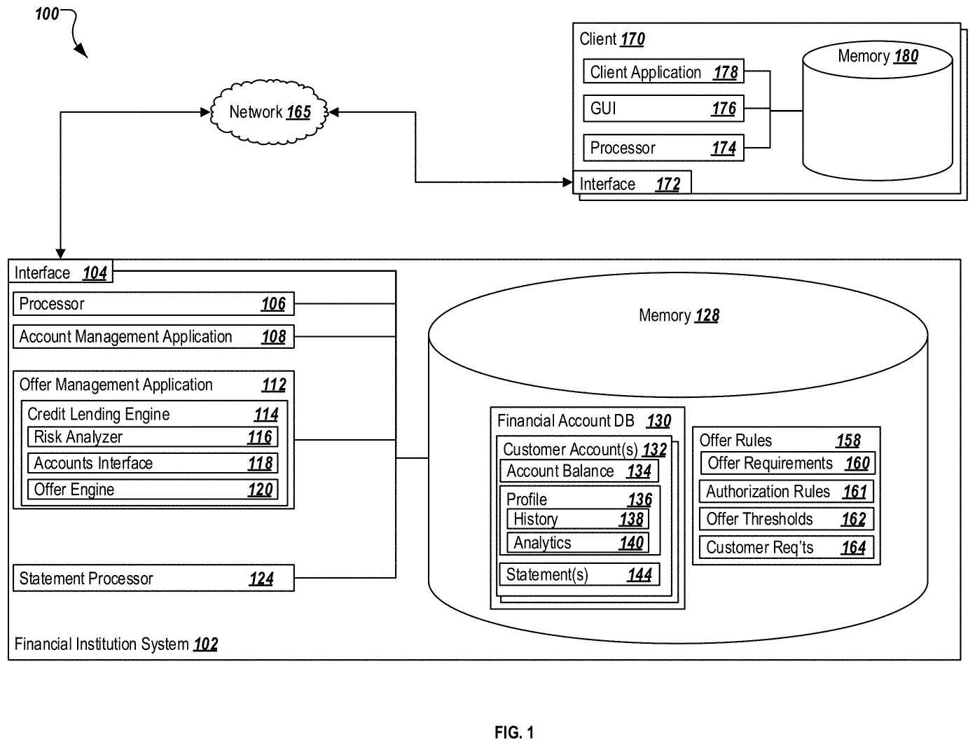

Turning to the illustrated example implementation, FIG. 1 is a block diagram illustrating an example system 100 for automatically identifying, providing, and implementing a lending offer to a customer based on an account analysis and a transaction that meets one or more authorization rules. In general, the system 100 allows the illustrated components to share and communicate information across devices and systems (e.g., FI system 102 and client 170, among others, via network 165). As described herein, the FI system 102 can be a cloud-based component or system (partially or fully), while in other instances, non-cloud systems can be used. In some instances, non-cloud-based systems, such as on-premise systems, client-server applications, and applications running on one or more client devices, as well as combinations thereof, can use or adapt the processes described herein. Although components are shown individually, in some implementations, functionality of two or more components, systems, or servers can be provided by a single component, system, or server.

As used in the present disclosure, the term “computer” is intended to encompass any suitable processing device. For example, FI system 102 and client 170 can be any computer or processing device such as, for example, a blade server, general-purpose personal computer (PC), Mac® workstation, UNIX-based workstation, or any other suitable device. Moreover, although FIG. 1 illustrates a single FI system 102, the FI system 102 can be implemented using a single system or more than those illustrated, as well as computers other than servers, including a server pool. In other words, the present disclosure contemplates computers other than general-purpose computers, as well as computers without conventional operating systems. Similarly, the client 170 can be any system that can request data and/or interact with the FI system 102. The client 170, also referred to as client device 170, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client 170 can include one or more specific applications executing on the client 170, or the client 170 can include one or more Web browsers or web applications that can interact with particular applications executing remotely from the client 170, such as the account management application 108 and the offer management application 112, among others.

The FI system 102 can be associated with the one or more applications or platforms, and can be associated with or a part of a cloud platform or system. As illustrated, the FI system 102 includes or is associated with interface 104, processor(s) 106, the account management application 108, offer management application 112, a statement processor 124, and memory 128. While illustrated as provided by or included in the FI system 102, parts of the illustrated contents can be separate or remote from the FI system 102. For example, while illustrated as a single system, the account management application 108 can be managed at a first system and/or application infrastructure while the offer management application 112 can be managed at a second system and/or application infrastructure. Similarly, the statement processor 124 can be managed at a third party system and/or application infrastructure. In some instances, the underlying FI system 102 can run the account management application 108 itself, while relying on one or more third parties to manage and provide functionality for offer management, as well as other operations such as statement processing. In those instances, the various applications can be able to communicate and interact with each other through internal and/or external communications, including via one or more channels and protocols, including through one or more dedicated application programming interfaces (APIs) and/or interfaces through which information needed to execute is available. For purposes of the present illustration, these portions are illustrated together for ease of description.

Returning to the FI system 102 illustrated in FIG. 1, the interface 104 is used by the FI system 102 for communicating with other systems in a distributed environment including within the system 100 connected to the network 165, e.g., client 170, and other systems communicably coupled to the illustrated FI system 102 and/or network 165. Generally, the interface 104 comprises logic encoded in software and/or hardware in a suitable combination and operable to communicate with the network 165 and other components. More specifically, the interface 104 can comprise software supporting one or more communication protocols associated with communications such that the network 165 and/or interface 104 hardware is operable to communicate physical signals within and outside of the illustrated system 100. Still further, the interface 104 can allow the FI system 102 to communicate with the client 170 and/or other portions illustrated within the FI system 102 to perform the operations described herein.

Network 165 facilitates wireless or wireline communications between the components of the system 100 (e.g., between the FI system 102, the client(s) 170, etc.), as well as with any other local or remote computers, such as additional mobile devices, clients, servers, or other devices communicably coupled to network 165, including those not illustrated in FIG. 1. In the illustrated environment, the network 165 is depicted as a single network, but can comprise more than one network without departing from the scope of this disclosure, so long as at least a portion of the network 165 can facilitate communications between senders and recipients. In some instances, one or more of the illustrated components (e.g., the offer management application 112, the statement processor 124, etc.) can be included within or deployed to network 165 or a portion thereof as one or more cloud-based services or operations. The network 165 can be all or a portion of an enterprise or secured network, while in another instance, at least a portion of the network 165 can represent a connection to the Internet. In some instances, a portion of the network 165 can be a virtual private network (VPN). Further, all or a portion of the network 165 can comprise either a wireline or wireless link. Example wireless links can include 802.11a/b/g/n/ac, 802.20, WiMax, LTE, and/or any other appropriate wireless link. In other words, the network 165 encompasses any internal or external network, networks, sub-network, or combination thereof operable to facilitate communications between various computing components inside and outside the illustrated system 100. The network 165 can communicate, for example, Internet Protocol (IP) packets, Frame Relay frames, Asynchronous Transfer Mode (ATM) cells, voice, video, data, and other suitable information between network addresses. The network 165 can also include one or more local area networks (LANs), radio access networks (RANs), metropolitan area networks (MANs), wide area networks (WANs), all or a portion of the Internet, and/or any other communication system or systems at one or more locations.

The FI system 102 also includes one or more processors 106. Although illustrated as a single processor 106 in FIG. 1, multiple processors can be used according to particular needs, desires, or particular implementations of the system 100. Each processor 106 can be a central processing unit (CPU), an application specific integrated circuit (ASIC), a field-programmable gate array (FPGA), or another suitable component. Generally, the processor 106 executes instructions and manipulates data to perform the operations of the FI system 102. Specifically, the processor 106 executes the algorithms and operations described in the illustrated figures, as well as the various software modules and functionality, including the functionality for sending communications to and receiving transmissions from clients 170, as well as to other devices and systems. Each processor 106 can have a single or multiple core, with each core available to host and execute an individual processing thread. Further, the number of, types of, and particular processors 106 used to execute the operations described herein can be dynamically determined based on a number of requests, interactions, and operations associated with the FI system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Peri®, any suitable version of 4GL, as well as others.

The FI system 102 can include, among other components, several applications, entities, programs, agents, or other software or similar components capable of performing the operations described herein. As illustrated, the FI system 102 includes or is associated with the account management application 108, the offer management application 112, and the statement processor 124.

The account management application 108 can be any application, program, other component, or combination thereof that is associated with a financial institution and used to manage and store user account-related information and metrics. The account management application 108 can access or receive information from one or more transactional systems, or can be a part of those transactional systems. The account management application 108 can collect and store information relating to various user accounts. In some instances, the account management application 108 can be a part of a system executing, for example, a Total System Services (TSYS) backend suite of applications managing one or more credit or other payment cards. The account management application 108 can, in some instances, store information relating to one or more payment card accounts, or accounts associated with one or more payment cards, as well as financial accounts associated with one or more loyalty and/or reward programs.

The account management application 108 can, in some instances, be associated with or manage a financial account database 130 or set of information, where the financial account database 130 can store information associated with one or more customer accounts 132. Each customer account 132 can be associated with a particular customer and/or specific customer account. Where customers are associated with multiple accounts, each customer account 132 can be linked to other related accounts, or can be separate. Each customer account 132 can be related to a payment card (e.g., a credit card), a financial account (e.g., a checking account), or both. Each customer account 132 can include an account balance 134, a profile 136, and one or more generated statements 144 for the customer account 132, although generated statements 144 can be stored separately in some instances. The account balance 134 can store information associated with a current account balance in a checking or savings account, a current balance associated with a credit card account as well as available credit associated with the credit card account, or any other information identifying a current balance of the corresponding customer account 132. The customer profile 136 can include any suitable information associated with the associated customer. In some instances, demographic information can be stored in the profile 136. As illustrated, an account history 138 can be included in the profile 136 and can be used to provide historical information related to account usage by the customer, such as historical spending or payment information, as well as timeliness information related to payments associated with the customer account 132 and/or other associated customer accounts 132. Further, a set of customer analytics 140 can also be included in or derived from the customer account 132 and historical information therein. For example, the analytics 140 can identify an average spending or payment amount on the customer account 132. For example, if a user spends, on average, $5,000 per month on the customer account 132, that information can be included in the analytics 140. Other analytics can be used by the offer management application 112 when determining whether particular offers are to be issued to the customer as described herein.

The offer management application 112 can be associated with a credit lending engine 114 used by the financial institution to identify and generate potential offers to customers based on any suitable combination of factors. The offer management application 112 can be associated with a separate offer management system, and can be associated with additional offers related to the financial institution, including offers for new credit cards, financial products, and other related items associated with the financial institution. In some instances, the offer management application 112 can be associated with, or a part of, the account management application 108. In the present illustration, the offer management application 112 can perform operations and functionality associated with identifying and offering customers the opportunity to repay in accordance with an installment plan in response to a large transaction or series of transactions of a credit account. To do so, the offer management application 112 can be associated with a credit lending engine 114. The credit lending engine 114 can be used to perform the specific analysis described herein, such as where the offer management application 112 is associated with additional and/or alternative operations including different types of offers for other products outside credit installment plans. The credit lending engine 114, as illustrated, includes a risk analyzer 116, an accounts interface 118, and an offer engine 120.

The risk analyzer 116 can perform a creditworthiness analysis based on one or more offer requirements 160 defined by the financial institution (and here, stored in memory 128), an account history 138, and one or more analytics 140. The offer requirements 160 can be used to determine whether the offer exceeds a predetermined offer threshold 162 (e.g., an offer will result in a customer debt-to-income ratio greater than a predetermined amount or the offer is, for example, 150% of the total value across all of a customer's accounts etc.). The risk analyzer 116 can access one or more databases and credit bureaus when making its determination based on the information provided via the network 165 and obtained from the FI system 102, if necessary, and, in some cases, can provide an instantaneous or near-instantaneous decision regarding a risk level associated with an offer.

The accounts interface 118 can access the customer accounts 132 to identify any relevant customer information, including a customer profile 136, to identify information related to whether an offer should be made. The offer engine 120 of the credit lending engine 114 can perform an analysis to determine whether a particular offer is to be provided, and further, can perform operations associated with initiating the loan if accepted. In particular, the offer engine 120 can access or execute a set of offer rules 158 stored in memory 128. The offer rules 158 can define information identifying particular situations and rules where such borrowing offers can be generated and provided to users. The offer rules 158 can be based on any suitable criteria and can be customized on a customer-by-customer basis, as well as based on customer classifications (e.g., card types, demographic information, customer tier level, customer spending history, customer historical transactions, etc.). The offer rules 158 can include one or more offer requirements 160, which can determine whether a current context or requirement for an offer to be made is met. Such rules can include requirements for an amount of allowable prior account delinquencies, an amount of credit a customer is allowed to withdraw, a term within which a particular loan must be repaid, a minimum interest rate or fee, and other suitable offer requirements 160. Additionally, a set of offer thresholds 162 can be defined to determine when such an offer can be made. In some examples, an absolute amount can be defined as a largest amount to be borrowed in any particular instance. For example, a particular rule can define a maximum amount to be offered as no more than $10,000 in a single offer. That offer threshold 162 can dynamically increase or decrease based on any number of factors, including a customer's credit limit, expected spending and/or points earning over a particular period of time, or any other analytics 140 or information about the customer. For example, if a customer has only earned, at most, $400 during each of the prior twelve periods, the maximum amount to be offered can be limited to $800 in total. In another example, the threshold can be limited to 10% of the total value across all of a customer's accounts. In another example, the customer can be limited to a total debt to income ratio. Any other suitable business-based rules and logic regarding how and when to offer loans can be included in the offer rules and can be at least partially defined in the offer thresholds 162. Similarly, a set of customer requirements 164 can be defined to ensure that only customers who meet certain customer criteria will receive such offers. In some instances, those requirements 164 can identify a particular minimum account age, a particular credit line amount for the customer account 132, or any other suitable requirement. In short, any suitable rule can be defined that allows the financial institution to identify customers with a suitable creditworthiness as it relates to the loan offer to ensure that such customers will repay any accepted or shifted (delayed) debt.

In some instances, the offer consideration and analysis can be performed periodically at particular intervals. In some instances, the frequency of the analysis can increase based on the likelihood a particular customer can be offered to borrow points or based on a relative ranking of customers. For example, a higher spender with a higher credit line can justify a more frequent analysis, as they may be more willing to accept the point loan. Alternatively, customers with whom the financial institution is looking to further engage and obtain additional business and transactions can be considered more often, thereby allowing the users to become more interested and/or sentimental to the card provider and/or the card associated with the offer. In some instances, the analysis can occur following every transaction that is determined to meet one or more authorization rules 161.

The authorization rules 161 can be any number of suitable defined rules or thresholds from which a determination to offer an installment plan can be used. For example the authorization rules 161 can be triggered due to a large purchase. In another example an authorization rule 161 can be triggered by a rapid series of transactions (e.g., a customer purchasing an airline ticket, rental car, and hotel room within a 6 hour window) that indicate a predetermined rate of change of a spending in a credit account, among other things. In some implementations, the customer or account holder must first indicate a desire for an installment plan for one or more transactions. In these examples, the offer engine 120 can verify the transactions selected by the customer satisfy one or more offer requirements 160, and then proceed with an offer. In some instances, a large purchase can be defined based on an absolute purchase amount (e.g., $1,000, $5,000, etc.), a purchase amount relative to account balance (e.g., 50% of total existing balance), a low account balance (e.g., less than $1,000 available credit remaining), and/or a large purchase relative to the credit user's recent transactions (e.g., user makes a purchase for $700, but has not spent more than $100 in a single purchase in the last 3 months). Additionally, authorization rules 161 can define which transactions are eligible for financing based on the transaction date. For example, any transaction that has posted within the past two payment periods (e.g., months) can be eligible. In some implementations, the customer can request an installment plan, even for transactions past their initial due date. Additional and similar options may be used in various implementations and on a case-by-case basis.

The statement processor 124 can perform operations to generate one or more statements 144 for customers. In particular, the statements 144 include information on an account balance 134 of the customer from a customer account 132. The statement processor 124 can be software or a process associated with a third-party vendor apart from the FI system 102, where the statement processor 124 can access the relevant customer accounts 132 in the financial account database 130. Statement processor 124 can update or modify account statements in response to a user accepting an installment plan. For example, if a customer account 132 was a credit account, and had an outstanding balance of $3,000, but the customer accepts an installment plan for a $1000.00 transaction for three payments of $350.00, the statement processor 124 can provide the customer with an updated statement with an outstanding balance of $2,350.00, while providing the remaining balance on future statements.

Memory 128 of the FI system 102 can represent a single memory or multiple memories. The memory 128 can include any memory or database module and can take the form of volatile or non-volatile memory including, without limitation, magnetic media, optical media, random access memory (RAM), read-only memory (ROM), removable media, or any other suitable local or remote memory component. The memory 128 can store various objects or data, including financial data, user and/or account information, administrative settings, password information, caches, applications, backup data, repositories storing business and/or dynamic information, and any other appropriate information associated with the FI system 102, including any parameters, variables, algorithms, instructions, rules, constraints, or references thereto. Additionally, the memory 128 can store any other appropriate data, such as VPN applications, firmware logs and policies, firewall policies, a security or access log, print or other reporting files, as well as others. While illustrated within the FI system 102, memory 128 or any portion thereof, including some or all of the particular illustrated components, can be located remote from the FI system 102 in some instances, including as a cloud application or repository or as a separate cloud application or repository when the FI system 102 itself is a cloud-based system. In some instances, some or all of memory 128 can be located in, associated with, or available through one or more other financial systems of the associated financial institution. In those examples, the data stored in memory 128 can be accessible, for example, via one of the described applications or systems. As illustrated and previously described, memory 128 includes the financial account database 130 and the offer rules 158, among others.

As illustrated, one or more clients 170 can be present in the example system 100. Each client 170 can be associated with one or more customer accounts 132, either as a client device at which the customer of the customer account 132 is linked, or as a client device through which the particular customer accesses financial information and can interact with one or more offers for a point balance loan. As illustrated, the client 170 can include an interface 172 for communication (similar to or different from interface 104), at least one processor 174 (similar to or different from processor 106), a graphical user interface (GUI) 176, a client application 178, and a memory 180 (similar to or different from memory 128).

The illustrated client 170 is intended to encompass any computing device such as a desktop computer, laptop/notebook computer, mobile device, smartphone, personal data assistant (PDA), tablet computing device, one or more processors within these devices, or any other suitable processing device. In general, the client 170 and its components can be adapted to execute any operating system, including Linux, UNIX, Windows, Mac OS®, Java™, Android™, or iOS. In some instances, the client 170 can comprise a computer that includes an input device, such as a keypad, touch screen, or other device(s) that can interact with one or more client applications, such as one or more dedicated mobile applications, including a mobile wallet or other banking application, and an output device that conveys information associated with the operation of the applications and their application windows to the user of the client 170. Such information can include digital data, visual information, or a GUI 176, as shown with respect to the client 170. Specifically, the client 170 can be any computing device operable to communicate with the FI system 102, other clients 170, and/or other components via network 165, as well as with the network 165 itself, using a wireline or wireless connection. In general, client 170 comprises an electronic computer device operable to receive, transmit, process, and store any appropriate data associated with the system 100 of FIG. 1.

The client application 178 executing on the client 170 can include any suitable application, program, mobile application, or other component. Client application 178 can interact with the FI applications (e.g., account management application 108 and offer management application 112) and the FI system 102 via network 165. In some instances, the client application 178 can be a web browser, where the functionality of the client application 178 can be realized using a web application or website the user can interact with via the client application 178. In other instances, the client application 178 can be a remote agent, component, or client-side version of the FI system 102 and/or any of its individual components. In some instances, the client application 178 can interact directly with the FI system 102 or portions thereof. The client application 178 can be used to view, interact with, and accept or decline one or more credit transaction loan offers based on user input, and/or can be used to present information associated with the operations of the credit loan offers and lending analysis after it is triggered. In some instances, the client application 178 may be a mobile application provided by or associated with the FI system 102, such that secure offers for the installment loans can be securely offered and accepted using the client application 178.

GUI 176 of the client 170 interfaces with at least a portion of the system 100 for any suitable purpose, including generating a visual representation of any particular client application 178 and/or the content associated with any components of the FI system 102. In particular, the GUI 176 can be used to present results of a point lending analysis, including providing one or more offers to the customer at the client 170, as well as to otherwise interact and present information associated with one or more applications. GUI 176 can also be used to view and interact with various web pages, applications, and web services located local or external to the client 170. Generally, the GUI 176 provides the user with an efficient and user-friendly presentation of data provided by or communicated within the system. The GUI 176 can comprise a plurality of customizable frames or views having interactive fields, pull-down lists, and buttons operated by the user. In general, the GUI 176 is often configurable, supports a combination of tables and graphs (bar, line, pie, status dials, etc.), and is able to build real time portals, application windows, and presentations. Therefore, the GUI 176 contemplates any suitable graphical user interface, such as a combination of a generic web browser, a web-enable application, intelligent engine, and command line interface (CLI) that processes information in the platform and efficiently presents the results to the user visually.

In some instances, portions of the interactions and FI system 102 data can be stored remotely within memory 180. As illustrated, memory 180 can store information related to instructions for operating various applications (i.e., client application 178) or other information associated with operation of the client 170. In some instances, additional information from the financial account database 130 is associated with the corresponding customer account 132 and loyalty account of the customer can be stored locally at memory 180 for use by the client application 178. In some instances, the client application 178 can be associated with a mobile wallet and can be used to store a set of mobile wallet data including information related to one or more cards and/or accounts, including in some instances, any associated loyalty account information.

While portions of the elements illustrated in FIG. 1 are shown as individual modules that implement the various features and functionality through various objects, methods, or other processes, the software can instead include a number of sub-modules, third-party services, components, libraries, and such, as appropriate. Conversely, the features and functionality of various components can be combined into single components as appropriate.

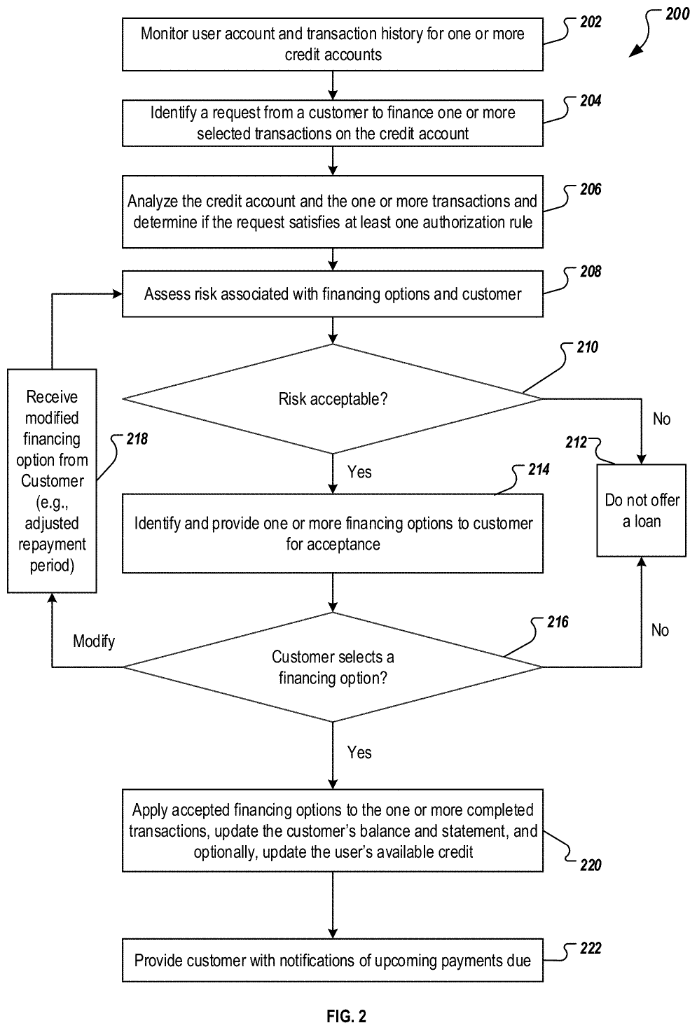

FIG. 2 is a flow diagram of an example method 200 for offering credit transaction financing by a financial institution in one example implementation. However, it will be understood that method 200 may be performed, for example, by any other suitable system, environment, software, and hardware, or a combination of systems, environments, software, and hardware as appropriate. In some instances, method 200 can be performed by the FI system 102, or portions thereof, described in FIG. 1, as well as other components or functionality described in other portions of this description. In other instances, method 200 may be performed by a plurality of connected components or systems. Any suitable system(s), architecture(s), or application(s) can be used to perform the illustrated operations.

In one instance, method 200 describes a method performed within a system of a financial institution or card provider comprising a communications module, at least one memory, and at least one hardware processor interoperably coupled with the at least one memory and the communications module. The at least one memory can include a repository storing a plurality of customer accounts for one or more customers. Each customer account in the plurality of customer accounts can store at least an account balance and a transaction history. In some instances, the customer account can store information about customer spending, transactions, analytics, and a customer profile. The memory may also store instructions that instruct the at least one hardware processor to perform particular operations.

At 202, one or more user account transaction histories are monitored for one or more credit accounts. In some instances, the user account and transaction history can be similar to the customer account 132 and history 138 as described in FIG. 1. The transaction history can include one or more transactions and details regarding the transaction (e.g., transaction amount, time, location, or receiving/paying parties etc.). In some instances, the user account transactions are monitored in real or near-real time, such that users may receive offers just, or shortly, after performing the transactions.

At 204, a request is identified from a customer to finance one or more selected transactions from the monitored credit account. In some implementations, the request can be received from an application executing on a client device (e.g., client device 170 as described in FIG. 1). The request can include a single transaction, or multiple transactions that have previously been completed. In some implementations, the request from the customer can be prompted by a financial institution. For example, when one or more transactions are determined to qualify for financing based on authorization rules, the financial institution can notify the customer or provide a recommendation to the customer, prompting the request (e.g., via text, email, pop-up message, etc.).

At 206, the credit account and the one or more selected transactions are analyzed to determine whether they satisfy at least one authorization rule from a repository of authorization rules. In some instances, the authorization rules can be similar to the authorization rules 161 as illustrated in FIG. 1. For example a transaction can satisfy an authorization rule if it is a large purchase or results in a low remaining available credit balance. In another example, a particular authorization rule 161 can be satisfied by a rapid series of transaction that indicate a rate of change of a balance in a credit account corresponding to a predetermined threshold defined generally or specifically for the user. In some instances, the analysis to determine whether a transaction satisfies at least one authorization rule can be performed prior to identifying the request. In these instances, the customer can be permitted to only request an installment plan for transactions that have already been analyzed and qualify based on the authorization rules. For example, when reviewing a list of transactions, only those that qualify may be selectable. Non-qualifying transactions can be grayed out, may not include a selectable UI element, or may otherwise be distinguished and non-selectable from the qualifying transactions.

At 208, a risk assessment is executed based on a multitude of factors. For example, the transaction history of the specific credit account, a set of offer requirements or thresholds provided by the financial institution, or one or more reports obtained from a third party entity such as a credit bureau, as well as other external information. In some instances, the risk assessment is executed by an application similar to the risk analyzer 116 of FIG. 1.

At 210, a determination is made whether or not the assessed risk is below a predetermined risk threshold. If it is determined that the risk is not below the predetermined threshold, method 200 can proceed to 212, where a loan offer is not made, or the request for installment financing is denied and method 200 ends for the current transaction. Method 200 may restart upon additional transactions being analyzed. Otherwise, if it is determined that the risk is below the predetermined risk threshold, method 200 continues at 214.

At 214, one or more financing options are generated and presented as a loan proposal to a user associated with the credit account. The loan proposal can be transmitted via a communications interface or any other suitable interface to a user device, which in some instances is similar to the client 170 as described in FIG. 1. The loan proposal can be associated with a set of terms determined based on set of customer-specific information and lending rules, where the loan proposal is provided to the user device for display. The set of terms can be, for example, a loan amount, a number of payments, a frequency of payments, an overall length, an installment plan, a fee or interest rate, or any suitable combination thereof. The loan offer can be presented to the user on the user device via a GUI, such as GUI 176 of FIG. 1. In some instances, the loan proposal can be presented in real time or near real time following the request for financing. In these instances, the loan offers may be in real time such that a request and an offer are temporally proximate; for example, an individual may perceive that the request and the offer occur substantially simultaneously, such as where the time difference for an offer following the suitable transaction can be less than 1 millisecond (ms) or less than 1 second (s), or, alternatively, the response can be without intentional delay taking into account processing limitations of the system.

At 216, an indication is received that identifies whether the user chooses to accept the offered loan or one of the provided financing options, provide one or more modifications to the loan, or reject the offer. If an indication that the user does not accept is received, then method 200 proceeds to 212 and the loan offer is withdrawn. If one or more modifications to the loan are provided, method 200 proceeds to 218 where the loan is modified (or analyzed for modification). If an indication that the user accepts the loan offer is received, then method 200 proceeds to 220. In those instances, the loan offer can be presented on a user device via a GUI and can include information including the set of terms and parameters that qualify the transaction for which the loan is being offered. Optionally, the offer can include information regarding the risk assessment or authorization rules satisfied. For example, the financial institution can send a user a notification via an application on their user device. In response to the user opening the application and requesting to financing a transaction, the user can be presented with a display that shows they are being offered a $1,000 loan for a fee of $44 with a repayment plan of 6 monthly payments of $174.

If the user selects the option to modify the proposed loan, at 218 the system can receive a new proposed loan and set of terms based on inputs from the user. In some instances, the user can adjust loan terms using a GUI which can include multiple sliders, menus, or other UI elements that allow the user to adjust one or more loan parameters. For example, the user may input a desired loan term of 3 months instead of 6 as previously offered. In this example, the loan can be modified, with new payment amounts and fees recalculated, and method 200 can return to 208 where risk is re-assessed based on the new loan parameters. In some instances, the loan can be bound within pre-approved thresholds and a re-assessment of risk is not required if the modifications stay within those thresholds, allowing for an automatic approval of the modified loan.

At 220, when the user accepts the loan offer, the selected transactions are automatically financed according to the accepted installment plan. The user's account balance is updated and the user can be provided with a new statement showing a different balance due. In some implementations, the user's available credit can also be adapted to account for a portion of the customer's debt being locked in a predetermined installment plan, as opposed to the revolving debt associated with the credit card.

Optionally, at 222, the system can provide the customer with notifications (e.g., push notifications or text messages) to ensure the customer is aware of upcoming payments that are due on the installment plan. In some implementations the system can establish automatic deduction from a debit account or another account associated with the user for repaying the loan.

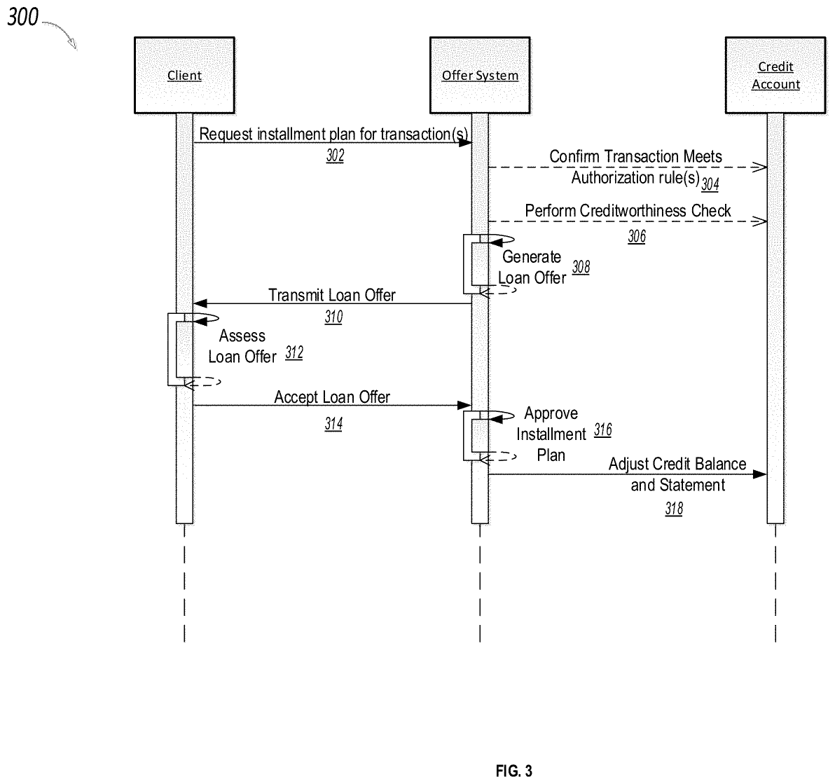

FIG. 3 is a swim-lane diagram depicting example interactions of a client, offer system, and credit account in an example method for offering credit based loans. The offer system can be managed or otherwise provided by a financial institution. In some instances, method 300 can be performed automatically by the offer system, without supervision by personnel associated with a financial institution. The offer system can be, for example, a software application similar to the offer management application 112 as described with reference to FIG. 1.

The offer system receives a request from the client for an installment plan for one or more transactions (302). The credit accounts can be associated with a one or more client, and can include a history of transactions. In some instances, the credit account can be similar to the customer account 132 as described in FIG. 1. In some implementations, the offer system can prompt the client, or otherwise notify the client of qualifying transactions automatically when one or more authorization rules are satisfied. In some instances, the offer system may service many customer accounts concurrently.

The offer system can in turn confirm that the one or more requested transactions meet one or more authorization rules (304). The identified transactions and authorization rules can be based on pre-determined parameters and automatic analyses performed by the financial institution. Any suitable requirements can be applied, including those related to historical customer-specific information (e.g., an expected direct deposit every 2 weeks of a known amount, an average account balance, etc.), particularly as associated with and evaluated in comparison to a particular transaction or set of transactions. The identified transaction may be larger than normal, may represent a particular percentage of the outstanding balance, or may otherwise be identified based on one or more static and/or dynamic rules. In some instances, the one or more authorization rules can be similar to the offer rules 158 as illustrated in FIG. 1. For example, a rule set similar to the offer rules 158 can be used to determine whether or not to provide on option for one or more transactions to be financed. A subset of the offer rules 158 (e.g., the authorization rules 161) can be used to determine, from among the transactions, which transactions qualify for potential financing.

Upon confirming the one or more requested transactions the offer system can perform a creditworthiness check on the credit account associated with the client (306). In doing so, risk associated with potential loans and installment plans can be evaluated in combination with the customer information. The creditworthiness check can access the credit account history, as well as other accounts associated with the client. If the risk is determined to be unacceptable for a particular loan and plan, then a lower risk loan and installment plan can be determined. A risk assessment engine (e.g., risk analyzer 116 of FIG. 1) can be used to determine whether the offer exceeds a predetermined risk threshold (e.g., an offer will result in a customer debt-to-income ratio greater than a predetermined amount or the offer is, for example, 150% of the total value across all of a customer's accounts etc.). The risk assessment engine can access one or more databases and credit bureaus when making its determination based on the information provided. In some cases, the risk assessment engine can provide an instantaneous or near-instantaneous decision regarding a risk level associated with an offer.

Following a creditworthiness check, the offer system generates a loan offer (308). The loan offer can have a set of terms and conditions which can be, for example, a loan amount, a number of payments, a frequency of payments, an overall length, an installment plan, a fee or interest rate, or any suitable combination thereof.

The generated loan can then be transmitted to a client device for review by the client (310). In some instances, the offer can be transmitted from the offer system to client and can be provided on a client device, such as through an email, text message, push notification, or other message or notification.

The client can then review and assess the received loan offer (312). In some instances, the client may reject the loan offer, in which case the loan offer is withdrawn. In other instances, the client may wish to modify, or otherwise alter one or more parameters associated with the loan. In those instances, a user interface (UI) can be provided with the presented offer, or can be accessible via interaction with the offer via a website or application presenting the offer. The UI can include a slider or other UI elements which can be used by the customer to adjust or modify one or more loan parameters. The results of those modifications can then be presented to the customer for further consideration. In some instances, the change can require an additional creditworthiness analysis. Alternatively, various thresholds can be pre-approved for the customer, such that the customer is able to adjust at least some of the parameters within a pre-determined or pre-calculated range. In some instances, the UI can present or illustrate those pre-approved variations for easy interaction.

Upon the client accepting the loan offer (314) the offer system can approve the accepted loan and installment plan. In some instances, the updated payments can be displayed to the customer as a separate account. In other instances, the newly financed transaction is reapplied to the current statement of the credit account.

After the installment plan is approved, the offer system can update the credit statement and balance of the credit account (318). In some instances, in addition to the client's end of month bill changing, more credit can be made available to the client based on the shift in debt (e.g., from a revolving debt plan to a fixed repayment plan).

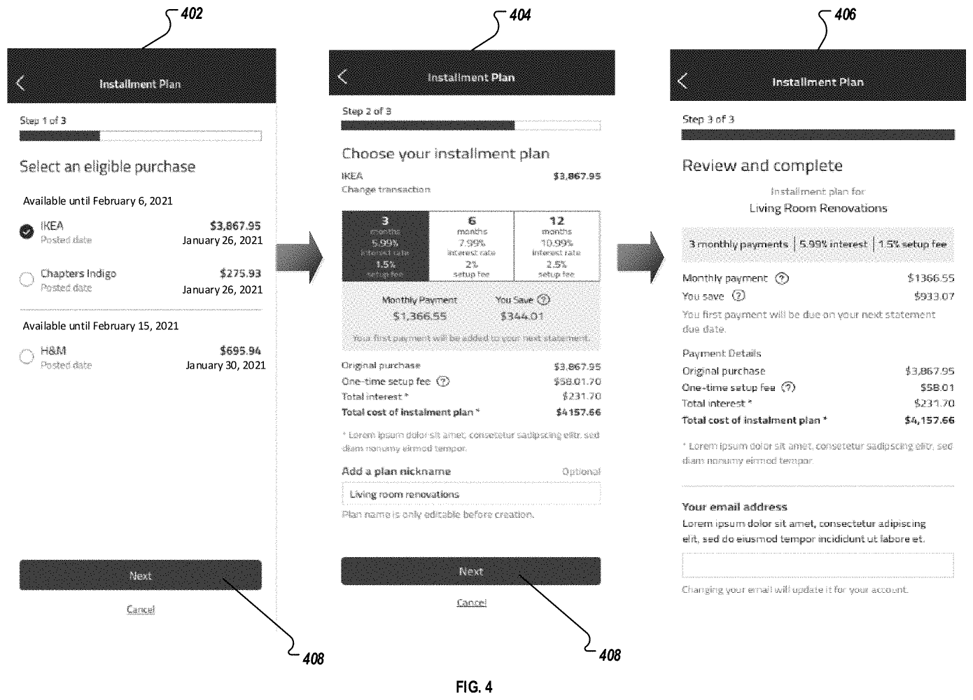

FIG. 4 illustrates an example user interface for requesting an installment plan that can be provided by an FI system to a customer. The user interface can provide a three step process. At screen 402, a list of eligible transactions are provided to the customer as well as the dates for which the transactions will be eligible for financing. In the illustrated example, the customer has selected the IKEA purchase of $3,867.95 for financing. Upon selecting the next button 408, the customer is presented with screen 404.

At screen 404, the customer is presented with multiple financing options for the selected transaction. In the example illustration, the customer has been presented with 3, 6, and 12 month options, each with unique interest rates and setup fees. In some implementations, there can be a constant or zero setup fee. In some implementations, the interest rate can be zero. Number illustrated in FIG. 4 are exemplary and could be altered without departing from the scope of this disclosure. In the illustrated example, the customer has selected a 3 month repayment plan with a 5.99% interest rate and a 1.5% setup fee. In some implementations, the customer can request a modification to one or more of the presented options. For example, the customer can request a reduced interest rate and the cost of a higher setup fee. In another example, the customer may request a reduced setup fee, or a deferred first payment, at the expense of a higher interest rate. Upon selecting a financing option, and pressing the next button 408, the customer is presented with screen 406.

At screen 406, a final review and confirmation of the details of the selected installment plan is provided for the customer. The customer can accept or cancel. In some implementations, the customer can be permitted to cancel the installment plan (and pay remaining amount of the transaction in full) any time after the plan has been approved. In some implementations, when cancelling, the setup fee, or a portion thereof (e.g., a prorated portion) can be refunded to the customer.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A system comprising:
a communications module;
at least one memory storing instructions, a repository storing a plurality of account profiles, and a repository storing a plurality of authorization rules, each account profile associated with a particular user and associated with at least one current credit account;
at least one hardware processor interoperably coupled with the at least one memory and the communications module, wherein the instructions instruct the at least one hardware processor to:
monitor at least one user credit account, wherein each user credit account is associated with a particular user, and wherein each user credit account includes a plurality of completed transactions;
analyze the plurality of completed transactions to identify a list of eligible transaction, wherein an eligible transaction is a transaction from the plurality of completed transactions that satisfies one or more authorization rules;
transmit the list of eligible transactions to the user device associated with the first user, wherein the list of eligible transactions is presented at the user device in an interactive graphical user interface (GUI);
identify a request associated with a particular user credit account, the identified request comprising a request for financing one or more eligible transactions of the list of eligible transactions selected using the interactive GUI, wherein the particular user credit account is associated with a first user;
in response to identifying the request:
identify one or more financing options for the one or more eligible completed transactions, each financing option comprising a fee and repayment period;
determine, for each financing option, that a risk associated with the financing option and the first user is below a predetermined threshold and, in response, approving the financing option; and
transmit a subset of the approved financing options to a user device associated with the first user for acceptance by the first user for presentation in the interactive GUI; and
in response to receiving an indication of acceptance of a particular one of the transmitted financing options from the first user via an interaction with the interactive GUI:
apply the accepted financing option to the one or more completed transactions; and
update the particular user credit account associated with the first user with a new balance.

2. The system of claim 1, wherein in response to receiving a modification request of a transmitted financing option from the first user via the user device:
modify the financing options in accordance with the modification request received from the user device;
analyze and determine, for the modified financing options, whether a risk associated with the modified financing options and the first user is below the predetermined threshold; and
in response to determining that the risk associated with the modified financing options and the first user is below the predetermined threshold, transmit the modified financing options to the user device associated with the first user for acceptance by the first user, the modified financing options indicating one or more parameters that have been modified from subset of the approved financing options.

3. The system of claim 2, wherein the predetermined threshold is a threshold below which risk is deemed acceptable, and wherein the predetermined threshold is based on a transaction amount, the first user, and a term of the modified financing options.

4. The system of claim 1, wherein a notification is transmitted to the user device indicating upcoming due payments.

5. The system of claim 1, wherein, after applying the accepted financing options, an available credit amount associated with the user credit account of the first user is modified.

6. The system of claim 1, wherein the at least one authorization rule comprises at least one of:
a determination that the at least one transaction is larger than a predetermined amount;
a determination that an available balance of the credit account is below a predetermined threshold immediately after the transaction;
a determination that the at least one transaction is greater than a predetermined percent of a total balance of the credit account; or
a determination that the at least one transaction represents a disproportionately sized transaction as compared to transactions from a transaction history of the first user.

7. (canceled)

8. The system of claim 1, wherein the list of eligible transactions is transmitted in response to an assessment that the eligible transactions meet at least one offer rule which triggers the transmission.

9. A computer-implemented method comprising:
monitoring at least one user credit account, wherein each user credit account is associated with a particular user, and wherein each user credit account includes a plurality of completed transactions;
analyzing the plurality of completed transactions to identify a list of eligible transaction, wherein an eligible transaction is a transaction from the plurality of completed transactions that satisfies one or more authorization rules;
transmitting the list of eligible transactions to the user device associated with the first user, wherein the list of eligible transactions is presented at the user device in an interactive graphical user interface (GUI);
identifying a request associated with a particular user credit account, the identified request comprising a request for financing one or more eligible transactions of the list of eligible transactions selected using the interactive GUI, wherein the particular user credit account is associated with a first user;
in response to identifying the request:
identifying one or more financing options for the one or more eligible transactions, each financing option comprising a fee and repayment period;
determining, for each financing option, that a risk associated with the financing option and the first user is below a predetermined threshold and, in response, approving the financing option; and
transmitting a subset of the approved financing options to a user device associated with the first user for acceptance by the first user for presentation in the interactive GUI; and
in response to receiving an indication of acceptance of a particular one of the transmitted financing options from the first user via an interaction with the interactive GUI:
applying the accepted financing option to the one or more completed transactions; and
updating the particular user credit account associated with the first user with a new balance.

10. The method of claim 9, wherein in response to receiving a modification request of a transmitted financing option from the first user via the user device:
modifying the financing options in accordance with the modification request received from the user device;
analyzing and determine, for the modified financing options, whether a risk associated with the modified financing options and the first user is below the predetermined threshold; and
in response to determining that the risk associated with the modified financing options and the first user is below the predetermined threshold, transmitting the modified financing options to the user device associated with the first user for acceptance by the first user, the modified financing options indicating one or more parameters that have been modified from subset of the approved financing options.

11. The method of claim 10, wherein the predetermined threshold is a threshold below which risk is deemed acceptable, and wherein the predetermined threshold is based on a transaction amount, the first user, and a term of the modified financing options.

12. The method of claim 9, wherein a notification is transmitted to the user device indicating upcoming due payments.

13. The method of claim 9, wherein, after applying the accepted financing options, an available credit amount associated with the user credit account of the first user is modified.

14. The method of claim 9, wherein the at least one authorization rule comprises at least one of:
a determination that the at least one transaction is larger than a predetermined amount;
a determination that an available balance of the credit account is below a predetermined threshold immediately after the transaction;
a determination that the at least one transaction is greater than a predetermined percent of a total balance of the credit account; or
a determination that the at least one transaction represents a disproportionately sized transaction as compared to transactions from a transaction history of the first user.

15. (canceled)

16. The method of claim 9, wherein the list of eligible transactions is transmitted in response to an assessment that the eligible transactions meet at least one offer rule which triggers the transmission.

17. A non-transitory, computer-readable medium storing computer-readable instructions executable by a computer and configured to:
monitor at least one user credit account, wherein each user credit account is associated with a particular user, and wherein each user credit account includes a plurality of completed transactions;
analyze the plurality of completed transactions to identify a list of eligible transaction, wherein an eligible transaction is a transaction from the plurality of completed transactions that satisfies one or more authorization rules;
transmit the list of eligible transactions to the user device associated with the first user, wherein the list of eligible transactions is presented at the user device in an interactive graphical user interface (GUI);
identify a request associated with a particular user credit account, the identified request comprising a request for financing one or more eligible transactions of the list of eligible transactions selected using the interactive GUI, wherein the particular user credit account is associated with a first user;
in response to identifying the request:
identify one or more financing options for the one or more eligible transactions, each financing option comprising a fee and repayment period;
determine, for each financing option, that a risk associated with the financing option and the first user is below a predetermined threshold and, in response, approving the financing option; and
transmit a subset of the approved financing options to a user device associated with the first user for acceptance by the first user for presentation in the interactive GUI; and
in response to receiving an indication of acceptance of a particular one of the transmitted financing options from the first user via an interaction with the interactive GUI:
apply the accepted financing option to the one or more completed transactions; and
update the particular user credit account associated with the first user with a new balance.

18. The computer-readable medium of claim 17, wherein in response to receiving a modification request of a transmitted financing option from the first user via the user device:
modify the financing options in accordance with the modification request received from the user device;
analyze and determine, for the modified financing options, whether a risk associated with the modified financing options and the first user is below the predetermined threshold; and
in response to determining that the risk associated with the modified financing options and the first user is below the predetermined threshold, transmit the modified financing options to the user device associated with the first user for acceptance by the first user, the modified financing options indicating one or more parameters that have been modified from subset of the approved financing options.

19. The computer-readable medium of claim 18, wherein the predetermined threshold is a threshold below which risk is deemed acceptable, and wherein the predetermined threshold is based on a transaction amount, the first user, and a term of the modified financing options.

20. The computer-readable medium of claim 17, wherein a notification is transmitted to the user device indicating upcoming due payments.

21. The system of claim 1, wherein the list of eligible transactions comprises a single transaction.
